(19) United States
(12) Patent Application Publication
(10) Pub. No.: US 2020/0025157 A1
(43) Pub. Date: Jan. 23, 2020

(54) EXHAUST GAS RECIRCULATION SYSTEM AND METHOD OF OPERATING THE SAME

(71) Applicant: GM GLOBAL TECHNOLOGY OPERATIONS LLC, Detroit, MI (US)

(72) Inventors: Roberto Romanato, Turin (IT); Stefano Pellegrino, Turin (IT)

(21) Appl. No.: 16/037,146

(22) Filed: Jul. 17, 2018

(51) Int. Cl. F02M 26/08; F02B 37/04; F02B 37/12; F02M 26/34; F02M 26/35; F02M 26/06

(52) U.S. Cl. CPC F02M 26/08; F02B 37/04; F02M 26/06; F02M 26/34; F02M 26/35; F02B 37/12

(57) ABSTRACT

An exhaust gas recirculation (EGR) system for a vehicle and method of operating the EGR system. The EGR system includes an internal combustion engine having an intake manifold; an aftertreatment device downstream of the internal combustion engine; an EGR valve downstream of the aftertreatment device; a main compressor; an electric compressor downstream of the main compressor; a low pressure (LP) loop coupled between the aftertreatment device and the intake manifold of the internal combustion engine; and an electronic control unit configured to operate the electric compressor depending on one or more operating parameters. The internal combustion engine uses exhaust from the LP loop without receiving exhaust from a high pressure (HP) loop.

The field of technology generally relates to exhaust gas recirculation (EGR) systems for vehicles and, more particularly, to low pressure (LP) EGR systems that include an electric compressor.

The EGR system supplements charge air into an internal combustion engine with exhaust gas. The EGR system can reduce nitrogen oxide (NOₓ) emissions and improve ignition quality. There are generally three types of EGR systems: low pressure (LP) loop EGR, high pressure (HP) loop EGR, and hybrid HGR systems which combine an LP loop and an HP loop. With an HP loop, a portion of the exhaust is routed from the internal combustion engine through an EGR valve (and also typically through an EGR cooler) through the intake valve and back through the internal combustion engine. In an HP loop, the exhaust is routed back through the internal combustion engine before reaching the exhaust turbine or an exhaust aftertreatment device. The route of recirculated exhaust for an HP loop is much shorter than an LP loop. In an LP loop, the recirculated exhaust is routed back to the internal combustion engine after it is treated by an exhaust after treatment device. Further, the LP loop system helps to promote turbocharger or main compressor performance by supplying recirculated exhaust gas at a point downstream of the turbine. Strategic thermal management and use of an electric compressor in addition to the main compressor allows for the use of an LP loop without an HP loop, which can lower system costs and result in a simpler, more streamlined EGR system.

### SUMMARY

According to one embodiment, there is provided an exhaust gas recirculation (EGR) system for a vehicle. The system comprises an internal combustion engine having an intake manifold; an aftertreatment device downstream of the internal combustion engine configured to change a composition of an exhaust from the internal combustion engine; an EGR valve downstream of the aftertreatment device; a main compressor; an electric compressor downstream of the main compressor, wherein the intake manifold of the internal combustion engine is downstream of the main compressor and the electric compressor; a low pressure (LP) loop coupled between the aftertreatment device and the intake manifold of the internal combustion engine, wherein the EGR valve, the main compressor, and the electric compressor are configured along the LP loop to feed at least a portion of the exhaust from the internal combustion engine to the intake manifold; and an electronic control unit configured to operate the electric compressor depending on one or more operating parameters. The internal combustion engine uses the portion of the exhaust from the LP loop without receiving exhaust from a high pressure (HP) loop.

According to various embodiments, this system may further include any one of the following features or any technically-feasible combination of these features:
the one or more operating parameters include a low pressure (LP) duty cycle, and the electronic control unit is configured to operate the electric compressor when the LP duty cycle is less than a maximum LP duty cycle;
the electric compressor is configured to create a negative pressure in the LP loop;
the vehicle is a hybrid vehicle comprising an electric motor, wherein the electric motor drives the electric compressor;
the hybrid vehicle is a mild 48-volt hybrid vehicle;
an air heater between the exhaust gas recirculation (EGR) valve and the main compressor;
the electronic control unit is configured to operate the air heater depending on the one or more operating parameters;
the one or more operating parameters include a main compressor inlet humidity, and the electronic control unit is configured to operate the air heater when the main compressor inlet humidity is greater than a maximum main compressor inlet humidity;
the one or more operating parameters include a main compressor inlet temperature, and the electronic control unit is configured to operate the air heater when the main compressor inlet temperature is less than a minimum main compressor inlet temperature;
the one or more operating parameters further include a main compressor inlet humidity, and the electronic control unit is configured to operate the air heater when the main compressor inlet humidity is greater than a maximum main compressor inlet humidity;
the main compressor inlet temperature and the main compressor inlet humidity are used by the electronic control unit as the one or more operating parameters used to operate the electric compressor, such that the electronic control unit is configured to operate the electric compressor when the main compressor inlet temperature is greater than a minimum main compressor inlet temperature and the main compressor inlet humidity is less than a maximum main compressor inlet humidity;
the one or more operating parameters includes a main compressor pressure ratio, wherein the electronic control unit is configured to assess one or more operating parameters in addition to the main compressor pressure ratio when the main compressor pressure ratio is greater than a maximum main compressor pressure ratio;
the exhaust gas recirculation (EGR) valve is configured to isolate the low pressure (LP) loop from an intake line, and the main compressor includes a separate intake for air from the intake line that is isolated from the LP loop; and/or
the exhaust gas recirculation (EGR) valve is located at a minimal distance from an intake of the main compressor to avoid condensation of water in the low pressure (LP) loop upstream of the main compressor and downstream of the EGR valve.

According to another embodiment, there is provided an exhaust gas recirculation (EGR) system for a vehicle. The system comprises an internal combustion engine having an intake manifold; an aftertreatment device downstream of the internal combustion engine configured to change a composition of an exhaust from the internal combustion engine; an EGR valve downstream of the aftertreatment device; an air heater downstream of the aftertreatment device; a main compressor downstream of the air heater; an electric compressor downstream of the main compressor, wherein the intake manifold of the internal combustion engine is downstream of the main compressor and the electric compressor; a low pressure (LP) loop coupled between the aftertreatment device and the intake manifold of the internal combustion engine, wherein the EGR valve, the air heater, the main compressor, and the electric compressor are configured along the LP loop to feed at least a portion of the exhaust from the internal combustion engine to the intake manifold; and an electronic control unit configured to operate the electric compressor and the air heater depending on one or more operating parameters.

According to various embodiments, this system may further include any one of the following features or any technically-feasible combination of these features:
the one or more operating parameters include a main compressor inlet humidity, and the electronic control unit is configured to operate the air heater when the main compressor inlet humidity is greater than a maximum main compressor inlet humidity; and/or
the one or more operating parameters include a main compressor inlet temperature, and the electronic control unit is configured to operate the air heater when the main compressor inlet temperature is less than a minimum main compressor inlet temperature.

According to another embodiment, there is provided a method of operating an exhaust gas recirculation (EGR) system. The method comprises the steps of outputting an exhaust from an internal combustion engine; circulating at least a portion of the exhaust through an aftertreatment device; changing a composition of the portion of the exhaust with the aftertreatment device; routing at least some of the portion of the exhaust in a low pressure (LP) loop through an EGR valve, a main compressor, and an electric compressor to the internal combustion engine without receiving exhaust from a high pressure (HP) loop; and operating the electric compressor with an electronic control unit depending on one or more operating parameters.

According to various embodiments, this method may further include any one of the following features or any technically-feasible combination of these features:
the step of heating the at least some of the portion of the exhaust with an air heater before the at least some of the portion of the exhaust is routed through the main compressor; and/or
the step of preventing condensation in the low pressure (LP) loop before the at least some of the portion of the exhaust is routed through the main compressor.

### BRIEF DESCRIPTION OF THE DRAWINGS

Preferred exemplary embodiments will hereinafter be described in conjunction with the appended drawings, wherein like designations denote like elements, and wherein:

FIG. 1 is a schematic representation of a vehicle exhaust gas recirculation (EGR) system according to the prior art;

FIG. 2 is a schematic representation of a vehicle EGR system according to one embodiment;

FIG. 3 is a schematic representation of a vehicle EGR system according to another embodiment;

FIG. 4 is a flowchart illustrating a method of operating an EGR system, such as the EGR system of FIG. 2; and

FIG. 5 is a flowchart illustrating parameters for operating an EGR system, such as the EGR system of FIG. 2.

### DETAILED DESCRIPTION

The system and method described herein relate to an exhaust gas recirculation (EGR) system configured to eliminate the need for a high pressure (HP) loop. Appropriate thermal management of a low pressure (LP) loop, in conjunction with an electric compressor to help boost performance of a main compressor, allows for a simplified system operable in a variety of different conditions. In some embodiments, an electric air heater is disposed in the LP loop and operated depending on the status of one or more operating parameters in order to avoid condensation related damage to the main compressor. Accordingly, the system can be designed to maximize the use of the LP loop in instances where it is typically not desirable to use an LP loop, such as during low load engine conditions.

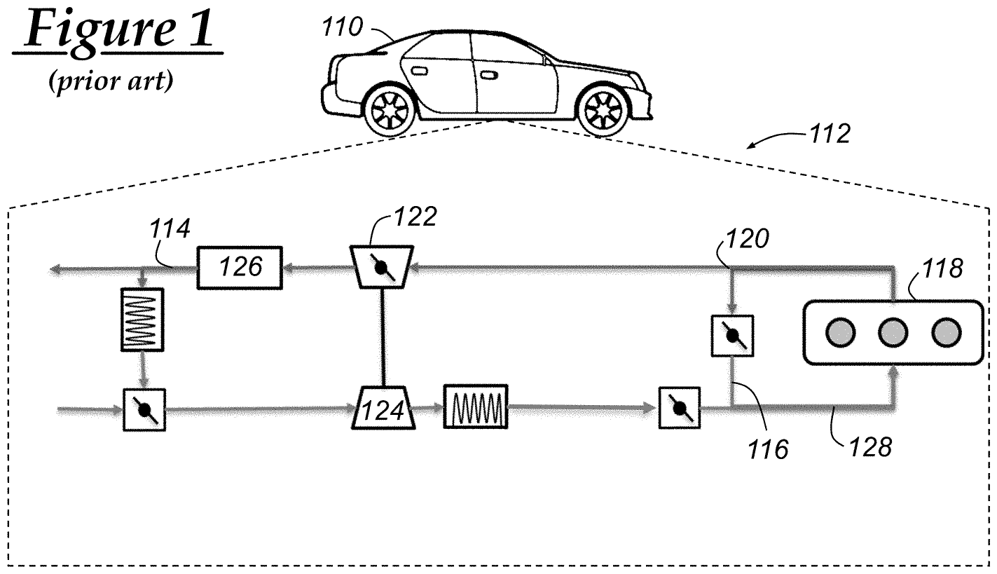

FIG. 1 illustrates a vehicle 110 having an EGR system 112 in accordance with the prior art. Typical systems, as that illustrated in FIG. 1, are hybrid EGR systems 112 that have both an LP loop 114 and an HP loop 116. The HP loop 116 is often used in circumstances when the engine 118 is under low load (e.g., less than 30% of the maximum rated load) or in instances where there is poor combustion efficiency. As shown in FIG. 1, the HP loop 116 sources exhaust back to the internal combustion engine 118 along the exhaust output 120 at a point upstream from the turbine 122, main compressor 124, and aftertreatment device 126. With the LP loop 114, however, the route is much longer, but can result in better performance of the main compressor 124. For example, if the aftertreatment device 126 includes a particulate filter, filtered exhaust can be fed to the intake manifold 128 which can help maintain engine durability. Further, the EGR cooling demands can be reduced in a system with the LP loop 114 without the HP loop 116. Another benefit of eliminating the HP loop 116 involves decreasing the amount of carbon dioxide released (about 3% in one example given the same emission level). Moreover, the system may cost less and be simplified in configuration and design without the HP loop 116.

### System—

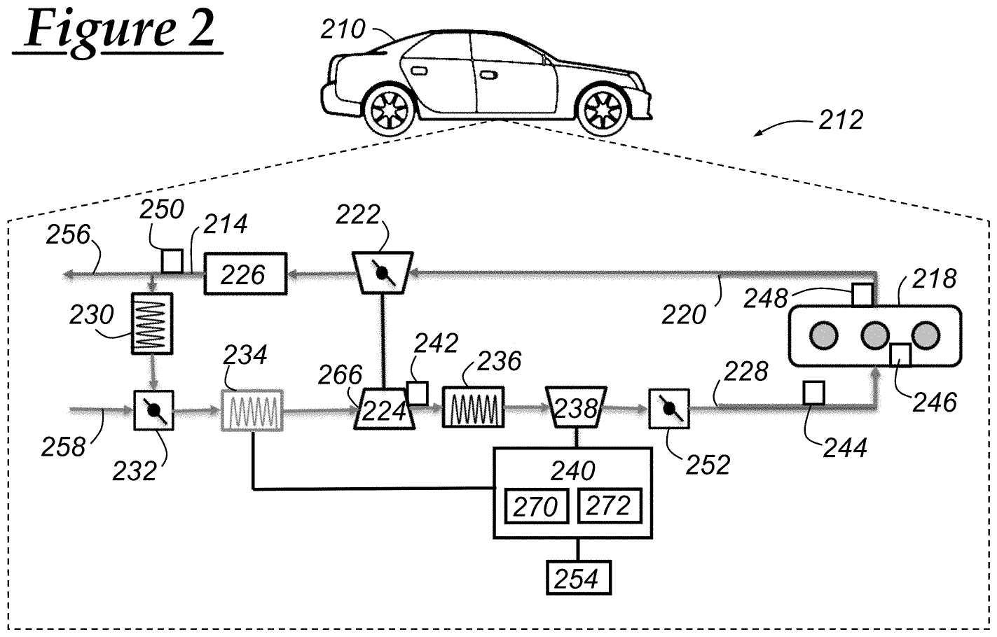

With reference to FIG. 2, there is shown a schematic representation of an example vehicle 210 equipped with an EGR system 212. It should be appreciated that the EGR systems and methods described herein may be used with any type of vehicle, including traditional passenger vehicles, sports utility vehicles (SUVs), cross-over vehicles, trucks, vans, buses, recreational vehicles (RVs), etc. These are merely some of the possible applications, as the EGR system 212 and method described herein are not limited to the exemplary embodiment shown in the figures and could be implemented with any number of different vehicles.

According to one embodiment, EGR system 212 includes an LP loop 214, an internal combustion engine 218, an exhaust output 220, a turbine 222 and main compressor 224, and an aftertreatment device 226. The LP loop 214 feeds exhaust from the internal combustion engine through an LP cooler 230, an EGR valve 232, and an air heater 234 before reaching the main compressor 224. Before introduction into the intake manifold 228 and downstream of the main compressor 224, the EGR system 212 may also include a cooler 236. Additionally, an electric compressor 238 is situated downstream of the main compressor 224 to help boost performance of the main compressor. Operation of the electric compressor 224, along with other components of the system 212, such as the air heater 234, may be accomplished with an electronic control unit (ECU) 240. Various sensors may provide information to the ECU 240 to operate the components of the EGR system 212, including but not limited to, a mass airflow and temperature sensor 242, a manifold pressure and temperature sensor 244, a combustion pressure sensor 246, an exhaust pressure and temperature sensor 248, and an EGR temperature sensor 250. In some embodiments, humidity is determined based on information derived from one or more pressure and temperature sensors, but in other embodiments, a separate humidity sensor may be used.

Any number of different sensors, components, devices, modules, systems, etc. may provide the EGR system 212 with information, data and/or other input. These include, for example, the components shown in FIG. 2 and sensors 242-250 listed above, as well as others that are known in the art but are not shown here. For example, the system may include a coolant level and temperature sensor, an oil level and temperature sensor, a fuel rail pressure sensor, a cam position sensor, a crank position sensor, an accelerator pedal position sensor, to cite a few possibilities. It should be appreciated that the various components of the LP loop 214, as well as any other component that is a part of and/or is used by the EGR system 212 may be embodied in hardware, software, firmware or some combination thereof. These components may directly sense or measure the conditions for which they are provided, or they may indirectly evaluate such conditions based on information provided by other sensors, components, devices, modules, systems, etc. Furthermore, these components may be directly coupled to the ECU 240, indirectly coupled via other electronic devices, a vehicle communications bus, network, etc., or coupled according to some other arrangement known in the art. These components may be integrated within another vehicle component, device, module, system, etc. (e.g., sensors that are associated a powertrain control module (PCM), an emissions control system, a fuel economy mode, etc.), they may be stand-alone components (as schematically shown in FIG. 2), or they may be provided according to some other arrangement. In some instances, multiple sensors might be employed to sense a single parameter (e.g., for providing redundancy). It should be appreciated that the foregoing scenarios represent only some of the possibilities, as any type of suitable arrangement or architecture may be used to carry out the methods described herein. For example, it is possible for the sensors and/or other components to be arranged in a different configuration.

The LP loop 214 allows for the supplementation of intake air with treated exhaust. Given that the exhaust does not have to be quickly rerouted to the intake manifold 228, the longer LP loop 214, as opposed to the HP loop in FIG. 1, can allow for more design freedom without the constraints of routing an HP loop in the EGR system. Moreover, the system 212 is more streamlined and less complex than the hybrid EGR system 112 shown in FIG. 1.

The internal combustion engine 218 can be a diesel or gasoline powered engine to cite two examples, although an alternate fuel source may be used. The engine 218 has one or more cylinders with a piston. The piston rotates a crankshaft via volumetric changes in the combustion chamber due to ignition and combustion of an air fuel mixture. The representation of the EGR system 212 and engine 218 is schematic, and accordingly, other features not illustrated may be provided, such as a fuel injection system, various valves or shafts, etc. A throttle 252 may be provided to regulate the flow of air into the intake manifold 228 for controlled distribution of air into the engine 218.

In an advantageous embodiment, the vehicle 210 is a hybrid vehicle such that the internal combustion engine 218 is not the only source of motive power. In an even more advantageous embodiment, the vehicle 210 is a mild 48-volt hybrid that lacks means for purely electrical propulsion, but includes features such as regenerative braking or selective stop/start of the engine 218 at particular times. In other embodiments, the vehicle 210 may be a full hybrid or a plug-in hybrid (PHEV). The vehicle 210 may have any operable hybrid arrangement, such as series, parallel, or power split, for example. The hybrid vehicle 210 includes an electric motor 254, which may be a motor/generator unit that is connected to a high-voltage battery or an energy storage system. The electric motor 254 drives the electric compressor 238. This arrangement allows for the electric compressor 238 to create a negative pressure in the LP loop 214 when necessary to supplement or boost the main compressor 224 and thereby provide a better torque response. The electric motor 254 may also be used to drive an electric air heater 234.

The main compressor 224 in this embodiment is a forced air system turbocharger. The main compressor 224 is rotationally coupled to the turbine 222. Rotation of the main compressor 224 increases the pressure and temperature of air in the LP loop 214 and accordingly in the manifold 228. The cooler 236 may accordingly be provided, such as a water charged air cooler, to reduce the temperature of the air. The turbine 222 rotates by receiving exhaust from the exhaust output 220, which directs exhaust from each of the cylinders. The exhaust exits the turbine 222 and is directed toward the aftertreatment device 226. The turbocharger may include a variable geometry turbine (VGT) with a VGT actuator arranged to move the vanes to alter the flow of exhaust through the turbine 222. In other embodiments, the main compressor 224 may have a fixed geometry turbine or include a waste gate.

The aftertreatment device 226 treats exhaust from the exhaust output 220. The aftertreatment device 226 may be any device that is configured to change the composition of the exhaust. Some examples include, but are not limited to, catalytic converters (two or three way), oxidation catalysts, lean NOₓ traps, hydrocarbon adsorbers, selective catalytic reduction (SCR) systems, and particulate filters. The aftertreatment device 226 may not be a separate or stand-alone device, as it may be associated with another component of the system 212 such as the turbine 222. After exposure to the aftertreatment device 226 a portion of the exhaust may be routed out an exhaust pipe 256.

The LP cooler 230 and EGR valve 232 are situated downstream of the aftertreatment device 226. The LP cooler 230 can reduce the temperature of the exhaust in the EGR system 212. Reducing the temperature of the exhaust can help reduce the in-cylinder combustion temperature which may reduce knocking potential. The EGR valve 232 regulates the flow of exhaust along the LP loop 214. As will be detailed further below, the EGR valve 232 can control the amount of intake air received from an intake port 258.

The air heater 234 works in conjunction with the electric compressor 238 (also referred to as an ecompressor or e-compressor) to facilitate usage of the LP loop 214 during instances such as periods of low engine load. Standard turbochargers, such as the main compressor 224, are not operative at idle, so the electric compressor 238 can create backpressure in the exhaust output 220 to recirculate low-pressure exhaust. Negative pressure in the LP loop 214 from the electric compressor 238 can increase the elaborated air mass usable in the intake manifold 228 for the engine 218. The electric compressor 238 is thus a separate component from the main compressor 224, and located downstream from the main compressor, to help pull exhaust through the LP loop 214 when the duty cycle of the LP EGR system 212 is less than a maximum duty cycle for the system.

The air heater 234 is situated in some embodiments between the EGR valve 232 and the main compressor 224. In one particular embodiment, a 0.5 kW intake air heater 234 may be powered by the electric motor 254, thereby leveraging the architecture of a mild hybrid, and accordingly, both the air heater 234 and the electric compressor 238 can be powered by the electric motor 254. This may simplify the control scheme; however, it is possible to have alternatively powered heaters or types of heaters.

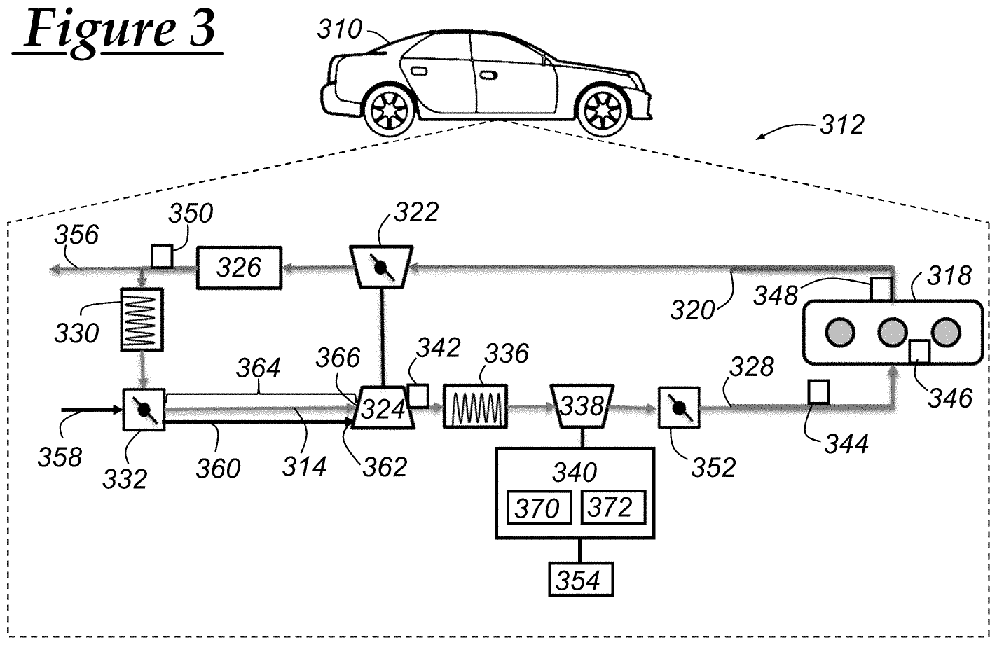

The air heater 234 may be advantageous in implementations where the layout design of the system 212 does not prevent condensation at cold ambient temperatures (e.g., −5° C. or less). Condensation of water from the exhaust in the LP loop 214 upstream of the main compressor 224 can negatively impact performance as physical droplets strike the spinning compressor wheel. Accordingly, use of the air heater 234 and/or one of the other solutions discussed with regard to FIG. 3 may help avoid the condensation phenomenon.

In FIG. 3, a separate air heater is not used, but two additional or alternate solutions for the condensation phenomenon are schematically illustrated in the EGR system 312 (like references denote like components). In one embodiment, a separate intake line 360 is configured to isolate the LP loop 314 and direct air to a separate intake 362 in the main compressor 324. In this embodiment, the outside air and exhaust do not meet until they reach the main compressor 324. This embodiment may require the use of an EGR valve 332 that is capable of isolating incoming air from exhaust output from the LP cooler 330. In an additional or alternate embodiment, the EGR valve 332 is located at a minimal distance 364 from an LP intake 366 to avoid condensation. The “minimal distance” is a distance in which a majority of the water vapor in the exhaust will not have time to condensate at an average speed and temperature of gas flow through the region between the EGR valve 332 and the main compressor 324. Accordingly, this distance may be dependent on configurational specifications of the EGR system 312. For example, if a particular system runs hotter on average, the minimal distance may be smaller. In another example, if the gas flow speed is faster, the minimal distance may be smaller.

Returning to FIG. 2, ECU 240 controls the air heater 234 and/or the electric compressor 238. It is possible for the ECU 240 to control other components in the EGR system 212, but the present disclosure is focused on control of the air heater 234 and/or the electric compressor 238 to effectuate use of the LP loop 214 without an HP loop. Accordingly, the ECU 240 may obtain feedback or information from numerous sources, such as sensors 242-250, and then control operation of the air heater 234 and/or the electric compressor 238 based on various operating parameters that may be ascertained based on the sensor information. The ECU 240 may be considered a controller, a control module, etc., and may include any variety of electronic processing devices, memory devices, input/output (I/O) devices, and/or other known components, and may perform various control and/or communication related functions. In an example embodiment, ECU 240 includes an electronic memory device 270 that stores sensor readings (e.g., sensor readings from sensors 242-250), look up tables or other data structures (e.g., look up tables relating to the calibratable operating parameters described below), algorithms (e.g., the algorithm embodied in the method described below), etc. The memory device 270 may maintain a buffer consisting of data collected over a predetermined period of time or during predetermined instances (e.g., LP loop parameters during engine start events). The memory device 270, or just a portion thereof, can be implemented or maintained in the form of an electronic data structure, as is understood in the art. ECU 240 also includes an electronic processing device 272 (e.g., a microprocessor, a microcontroller, an application specific integrated circuit (ASIC), etc.) that executes instructions for software, firmware, programs, algorithms, scripts, etc. that are stored in memory device 270 and may partially govern the processes and methods described herein.

Depending on the particular embodiment, the ECU 240 may be a stand-alone vehicle electronic module (e.g., an engine controller, a specialized EGR controller, etc.), it may be incorporated or included within another vehicle electronic module (e.g., a powertrain control module, an automated driving control module, etc.), or it may be part of a larger network or system (e.g., an automated driving system, a fuel efficiency system, etc.), to name a few possibilities. Accordingly, the ECU 240 is not limited to any one particular embodiment or arrangement and may be used by the present method to control one or more aspects of EGR system 212 operation. The EGR system 212 and/or ECU 240 may also include a calibration file, which is a setup file that defines the commands given to the actuating components such as the main compressor 224, the air heater 234, and the electric compressor 238. The commands govern the EGR system 212 and may include, for example, the ability to alter a pulse width modulated power control signal.

### Method—

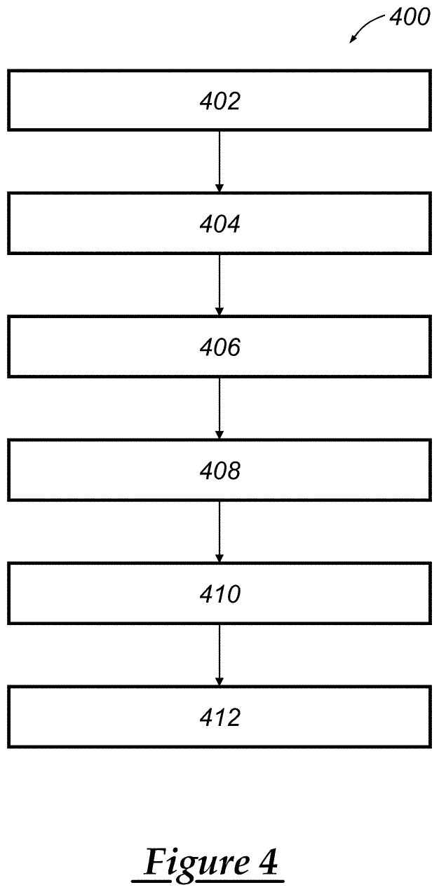

FIG. 4 illustrates a method 400 for operating an EGR system using the system described above with respect to FIG. 2. It should be understood that the steps of the method 400 are not necessarily presented in any particular order and that performance of some or all the steps in an alternative order is possible and is contemplated. Further, it is likely that the method 400 could be implemented in other systems that are different from the system 212 illustrated in FIG. 2, such as the system 312 of FIG. 3 or another system not illustrated, and that the description of the method 400 within the context of the system 212 is only an example.

The method 400 begins at step 402, by outputting exhaust from an internal combustion engine. Exhaust resulting from the combustion of the air/fuel mixture in the engine 218 enters the exhaust output 220. The exhaust includes various by-products such as NOx, CO2, and H2O. The ECU 240 can monitor one or more qualities or conditions relating to the output of exhaust, with the exhaust pressure and temperature sensor 248, to cite one example.

Step 404 of the method involves circulating at least a portion of the exhaust through an aftertreatment device, such as aftertreatment device 226, and step 206 involves changing a composition of the portion of the exhaust with the aftertreatment device 226. These steps may involve reducing particulate matter in the exhaust, such as with a particulate filter, or chemically changing the composition of the exhaust, such as with a catalytic converter, an oxidation catalysts or SCR system. The use of lean NOx traps or hydrocarbon adsorbers is also possible, as are other aftertreatment procedures that alter the exhaust.

Step 408 of the method involves routing at least some of the exhaust that was treated in steps 404 and 406 in the LP loop 214 through the EGR valve 232, the main compressor 224, and the electric compressor 238. Ultimately, at least some of the routed exhaust is used in the intake for the internal combustion engine 218. Mixing this exhaust with intake area causes changes in the composition of the gas introduced into the internal combustion engine 218. Most particularly, the oxygen fraction is likely to decrease and the fraction of combustion by-products such as CO2 and H2O will increase. As detailed below, appropriate thermal management can help lessen the likelihood of the H2O in the exhaust condensating and causing damage to the main compressor 224. The portion of the exhaust that is not used for EGR purposes may be output from the system via exhaust pipe 256. Step 408 may also include cooling the routed exhaust with the LP cooler 330 before it is mixed with incoming or charge air at the EGR valve 332.

Steps 410 and 412 of the method involve operating the electric compressor 238 and an air heater 234 (in embodiments in which an air heater is used), respectively. Step 412 will not be performed in embodiments where the EGR system 212 does not include a separate air heater between the EGR valve 212 and the main compressor 224, such as the embodiments illustrated in FIG. 3. Again, these examples and the outputs of the method 400 will vary depending on factors such as the EGR system, the driving mode, as well as other characteristics.

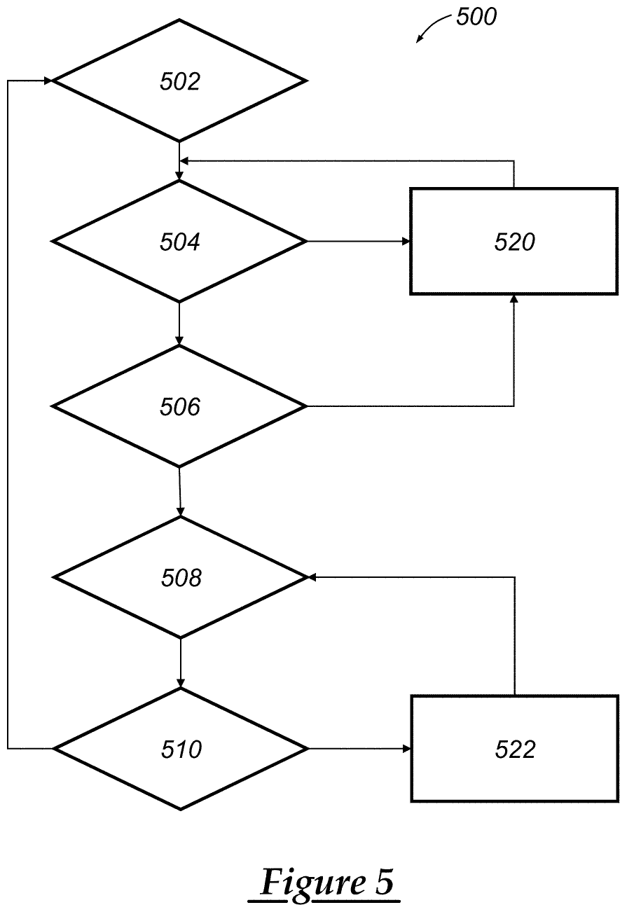

FIG. 5 illustrates a method 500 that may be used to accomplish steps 410 and 412 of the method 400. Steps 502-510 involve the verification or comparison of various operating parameters that may be used to operate the electric compressor 238 and/or the air heater 234. These operating parameters include, but are not limited to: a main compressor pressure ratio (step 502), a main compressor inlet humidity (step 504), a main compressor inlet temperature (step 506), an LP-EGR ratio (step 508), and an LP duty cycle (step 510). The verification order may change from what is illustrated in FIG. 5, as FIG. 5 is just merely one embodiment. For example, steps 504 and 506 may be reordered such that the inlet temperature is verified before the inlet humidity is verified. Further, as addressed, in implementations without an air heater 234, the method may cycle through steps 502-510 without operating the air heater such that the operating parameters only effectuate changes in operation to the electric compressor 238. The checks of these operating parameters, however, may be used by the ECU 240 for example to effectuate operational signals for other components or devices in the EGR system 212. It should also be understood that recitations of comparing steps such as “less than” or “greater than” are open-ended such that they could include “less than or equal to” or “greater than or equal to,” respectively, and this will depend on the established parameter evaluations in the desired implementation.

Step 502 is an initial or standard check to avoid compressor surge and involves verifying the compressor pressure ratio (Beta_cmp) of the main compressor 224. If the current ratio is greater than an allowed maximum ratio (e.g., Beta_cmp>Beta_cmp_max), then the initial check is verified. The compressor pressure ratio may be derived by the ECU 240, for example, from information received from sensors 242-250. The maximum allowable ratio can be determined from a calibratable array as a function of the main compressor flow. Step 502 may be accomplished as an initial check to see whether a change in the LP EGR system 212 is feasible.

Steps 504 and 506 include the verification of certain operating parameters that may be used for operating air heater 234 and the electric compressor 238. This involves a more streamlined and efficient operational scheme, as the same algorithm can be used for the operation of both components. Step 504 checks the main compressor inlet humidity operating parameter. This may be derived from sensors 242-250, or it may be received from a distinct humidity sensor or a general ambient condition sensor, to cite a few examples. As described above, since the recirculated exhaust travels through the long LP loop 214 before reaching the main compressor 224, recirculated water vapor in the exhaust could be condensed into liquid water droplets, which could cause structural issues for the main compressor 224. Thus, step 504 checks that the actual value of the main compressor inlet humidity (RH_comp_in) is lower than an allowed maximum value (RH_max). The maximum main compressor inlet humidity can be determined from a calibratable array as a function of the LP EGR rate. When the main compressor inlet humidity is greater than the allowed maximum, the air heater 234 is operated in step 520. The air heater 234 may be activated until the verification in step 504 is accomplished (e.g., the air heater 234 remains on until the main compressor inlet humidity is less than the maximum).

Once the main compressor inlet humidity is less than the maximum, the method continues to step 506 to check the main compressor inlet temperature (T_comp_in). As mentioned above, steps 504 and 506 may be reordered such that temperature is checked before humidity. In step 506, the inlet temperature of the main compressor 224 may be derived from information from sensors 242-250, or it may be obtained from a dedicated sensor positioned at the intake 266 of the main compressor 224. Step 506 then checks that the actual valve of the main compressor inlet temperature (T_comp_in) is greater than an allowed minimum value (T_min). The allowed minimum value is a calibratable value as well. When the main compressor inlet temperature is less than the minimum, the air heater 234 is operated in step 520. The air heater 234 may be activated until the verification in step 506 is accomplished (e.g., the air heater 234 remains on until the main compressor inlet temperature is greater than the minimum).

Once the main compressor inlet temperature is greater than the minimum, the method continues to step 508 to check the LP-EGR ratio. The LP-EGR ratio may be derived using information from sensors 242-250 to determine, for example, the volume or mass of recirculated exhaust gas relative to the total diluted charge airflow rate. If the current or actual value of the LP-EGR ratio is less than a maximum LP-EGR ratio (LP-EGR ratio max) for emission stability purposes (such ratio values are available from a calibratable look-up table), then the method continues to step 510.

In step 510, the LP duty cycle is verified. The LP duty cycle may be derived using information from sensors 242-250 or it may be ascertainable by the ECU 240 itself. For example, if the EGR valve 232 is a solenoid valve, the duty cycle may be the ratio of solenoid on to solenoid off time. The LP duty cycle is compared against a maximum LP duty cycle, which is a calibratable value. At the maximum LP duty cycle, no more exhaust can be recycled. Accordingly, this step maximizes the use of LP exhaust, because when the LP duty cycle is less than the maximum allowable, the electric compressor 238 is activated in step 522. The electric compressor 238 may be activated until the LP duty cycle reaches the maximum LP duty cycle. This may be accomplished by altering the power signal to the electric compressor 238 that is sent from the ECU, for example. The power may be proportionally adjusted in some embodiments depending on the delta or difference between the actual LP duty cycle and the maximum LP duty cycle. Activation of the electric compressor 538 may also be dependent on the LP-EGR ratio verification in step 508. For example, activation of the electric compressor 238 may involve verifying that the LP-EGR ratio is less than a maximum LP-EGR ratio. Activating the electric compressor in step 522, depending on the operating parameters evaluated in steps 502-510, allows for boosting and improved performance of the main compressor 224.

It is to be understood that the foregoing description is not a definition of the invention, but is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. For example, the specific combination and order of steps is just one possibility, as the present method may include a combination of steps that has fewer, greater or different steps than that shown here. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that that the listing is not to be considered as excluding other, additional components or items. Other terms are to be construed using their broadest reasonable meaning unless they are used in a context that requires a different interpretation.

What is claimed is:

1. An exhaust gas recirculation (EGR) system for a vehicle, comprising:
an internal combustion engine having an intake manifold;
an aftertreatment device downstream of the internal combustion engine configured to change a composition of an exhaust from the internal combustion engine;
an EGR valve downstream of the aftertreatment device;
a main compressor;
an electric compressor downstream of the main compressor, wherein the intake manifold of the internal combustion engine is downstream of the main compressor and the electric compressor;
a low pressure (LP) loop coupled between the aftertreatment device and the intake manifold of the internal combustion engine, wherein the EGR valve, the main compressor, and the electric compressor are configured along the LP loop to feed at least a portion of the exhaust from the internal combustion engine to the intake manifold; and
an electronic control unit configured to operate the electric compressor depending on one or more operating parameters, wherein the internal combustion engine uses the portion of the exhaust from the LP loop without receiving exhaust from a high pressure (HP) loop.

2. The system of claim 1, wherein the one or more operating parameters include a low pressure (LP) duty cycle, and the electronic control unit is configured to operate the electric compressor when the LP duty cycle is less than a maximum LP duty cycle.

3. The system of claim 2, wherein the electric compressor is configured to create a negative pressure in the LP loop.

4. The system of claim 1, wherein the vehicle is a hybrid vehicle comprising an electric motor, wherein the electric motor drives the electric compressor.

5. The system of claim 4, wherein the hybrid vehicle is a mild 48-volt hybrid vehicle.

6. The system of claim 1, further comprising an air heater between the exhaust gas recirculation (EGR) valve and the main compressor.

7. The system of claim 6, wherein the electronic control unit is configured to operate the air heater depending on the one or more operating parameters.

8. The system of claim 7, wherein the one or more operating parameters include a main compressor inlet humidity, and the electronic control unit is configured to operate the air heater when the main compressor inlet humidity is greater than a maximum main compressor inlet humidity.

9. The system of claim 7, wherein the one or more operating parameters include a main compressor inlet temperature, and the electronic control unit is configured to operate the air heater when the main compressor inlet temperature is less than a minimum main compressor inlet temperature.

10. The system of claim 9, wherein the one or more operating parameters further include a main compressor inlet humidity, and the electronic control unit is configured to operate the air heater when the main compressor inlet humidity is greater than a maximum main compressor inlet humidity.

11. The system of claim 10, wherein the main compressor inlet temperature and the main compressor inlet humidity are used by the electronic control unit as the one or more operating parameters used to operate the electric compressor, such that the electronic control unit is configured to operate the electric compressor when the main compressor inlet temperature is greater than a minimum main compressor inlet temperature and the main compressor inlet humidity is less than a maximum main compressor inlet humidity.

12. The system of claim 7, wherein the one or more operating parameters includes a main compressor pressure ratio, wherein the electronic control unit is configured to assess one or more operating parameters in addition to the main compressor pressure ratio when the main compressor pressure ratio is greater than a maximum main compressor pressure ratio.

13. The system of claim 1, wherein the exhaust gas recirculation (EGR) valve is configured to isolate the low pressure (LP) loop from an intake line, and the main compressor includes a separate intake for air from the intake line that is isolated from the LP loop.

14. The system of claim 1, wherein the exhaust gas recirculation (EGR) valve is located at a minimal distance from an intake of the main compressor to avoid condensation of water in the low pressure (LP) loop upstream of the main compressor and downstream of the EGR valve.

15. An exhaust gas recirculation (EGR) system for a vehicle, comprising:
an internal combustion engine having an intake manifold;
an aftertreatment device downstream of the internal combustion engine configured to change a composition of an exhaust from the internal combustion engine;
an EGR valve downstream of the aftertreatment device;
an air heater downstream of the aftertreatment device;
a main compressor downstream of the air heater;
an electric compressor downstream of the main compressor, wherein the intake manifold of the internal combustion engine is downstream of the main compressor and the electric compressor;
a low pressure (LP) loop coupled between the aftertreatment device and the intake manifold of the internal combustion engine, wherein the EGR valve, the air heater, the main compressor, and the electric compressor are configured along the LP loop to feed at least a portion of the exhaust from the internal combustion engine to the intake manifold; and
an electronic control unit configured to operate the electric compressor and the air heater depending on one or more operating parameters.

16. The system of claim 15, wherein the one or more operating parameters include a main compressor inlet humidity, and the electronic control unit is configured to operate the air heater when the main compressor inlet humidity is greater than a maximum main compressor inlet humidity.

17. The system of claim 15, wherein the one or more operating parameters include a main compressor inlet temperature, and the electronic control unit is configured to operate the air heater when the main compressor inlet temperature is less than a minimum main compressor inlet temperature.

18. A method for operating an exhaust gas recirculation (EGR) system for a vehicle, the method comprising the steps of:
outputting an exhaust from an internal combustion engine;
circulating at least a portion of the exhaust through an aftertreatment device;
changing a composition of the portion of the exhaust with the aftertreatment device;
routing at least some of the portion of the exhaust in a low pressure (LP) loop through an EGR valve, a main compressor, and an electric compressor to the internal combustion engine without receiving exhaust from a high pressure (HP) loop; and
operating the electric compressor with an electronic control unit depending on one or more operating parameters.

19. The method of claim 18, further comprising the step of heating the at least some of the portion of the exhaust with an air heater before the at least some of the portion of the exhaust is routed through the main compressor.

20. The method of claim 18, further comprising the step of preventing condensation in the low pressure (LP) loop before the at least some of the portion of the exhaust is routed through the main compressor.
